(19) United States
(12) Patent Application Publication
(10) Pub. No.: US 2026/0295490 A1
(43) Pub. Date: Oct. 1, 2026

(54) GAS FILTER ELEMENT, FILTER DEVICE AND METHOD OF USE

(71) Applicant: Pall Corporation, Port Washington, NY (US)

(72) Inventor: Keith REKCZIS, Port Washington, NY (US)

(21) Appl. No.: 19/490,096

(22) PCT Filed: Jun. 24, 2024
(86) PCT No.: PCT/US2024/035266

§ 371 Date: Dec. 4, 2025

Related U.S. Application Data
(60) Provisional application No. 63/530,391, filed on Aug. 2, 2023.

(51) Int. Cl. B01D 46/24; F01N 3/022; F01N 13/00

(52) U.S. Cl. CPC B01D 46/2451; B01D 46/2422; F01N 3/022; F01N 13/017

(57) ABSTRACT

A gas filter element comprising: a first end and a second end, having a plurality of inlet channels and a plurality of slotted outlet channels between the first end and the second end, wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded by 4 slotted outlet channels; each of the plurality of inlet channels and each of the plurality of plurality of slotted outlet channels having an inner cross-sectional area, each of the plurality of inlet channels having an inner cross-sectional area exceeding the inner cross-sectional area of each of the plurality of slotted outlet channels.

### BACKGROUND OF THE INVENTION

There is increasing interest in filtering gas, which may including capturing carbon by removing it from a gas such as flue gas (e.g., by capturing carbon dioxide (CO₂) emissions from power plants and industrial facilities) in order to, for example, fight climate change. There is a need for improved filters for removing solid contaminants from a fluid, e.g., to protect carbon capture systems and/or there is a need for capturing carbon in gas.

The present invention provides for ameliorating at least some of the disadvantages of the prior art. These and other advantages of the present invention will be apparent from the description as set forth below.

### BRIEF SUMMARY OF THE INVENTION

An aspect of the invention provides a gas filter element, comprising a first end and a second end, having a plurality of inlet channels and a plurality of slotted outlet channels between the first end and the second end, wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded by 4 slotted outlet channels; each of the plurality of inlet channels and each of the plurality of plurality of slotted outlet channels having an inner cross-sectional area, each of the plurality of inlet channels having an inner cross-sectional area exceeding the inner cross-sectional area of each of the plurality of slotted outlet channels; the plurality of inlet channels and the plurality of slotted outlet channels having common porous walls.

In accordance with another aspect of the invention, a gas filter element comprises: a first end and a second end, having a plurality of inlet channels and a plurality of slotted outlet channels between the first end and the second end, wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded on 2 opposing sides by 2 slotted outlet channels; each of the plurality of inlet channels and each of the plurality of plurality of slotted outlet channels having an inner tapered cross-sectional area, the tapered inner cross-sectional area of each of the plurality of inlet channels decreasing from the first end to the second end; and the tapered inner cross-sectional area of each of the plurality of slotted outlet channels decreasing from the second end to the first end; the plurality of inlet channels and the plurality of slotted outlet channels having common porous walls.

In accordance with another aspect of the invention, a gas filter element comprises: a first end and a second end, having a plurality of inlet channels and a plurality of outlet channels between the first end and the second end, wherein, in an alternating pattern, the plurality of inlet channels each have an inlet channel opening at the first end, and are closed at the second end, and the plurality of outlet channels each have an outlet channel closed at the first end, and an opening at the second end, each outlet channel forming a gap between adjacent inlet channels, the gap extending to the second end; each of the plurality of inlet channels being surrounded by outlet channels, each inlet channel surrounded by outlet channels forming an individual channel unit, each individual channel unit surrounded by the gap extending to the second end, such that adjacent individual channel units do not contact one another; the plurality of inlet channels and the plurality of outlet channels in each individual channel unit having common porous walls.

In accordance with another aspect of the invention, a gas filter element comprises: a first end and a second end, having a plurality of inlet channels and a plurality of outlet channels between the first end and the second end, wherein, in an alternating pattern, the plurality of inlet channels each have an inlet channel opening at the first end, and are closed at the second end, and the plurality of outlet channels each have an outlet channel closed at the first end, and an opening at the second end, each outlet channel forming a gap between adjacent inlet channels along a partial length between the first end and the second end; each of the plurality of inlet channels being surrounded by outlet channels, each inlet channel surrounded by outlet channels forming an individual channel unit, each individual channel unit surrounded by the gap along the partial length between the first end and the second end, wherein adjacent individual channel units are held together by a support bracket; the plurality of inlet channels and the plurality of outlet channels in each individual channel unit having common porous walls.

In some aspects of the gas filter element, the element has a ratio of inner cross-sectional area of all of the plurality of inlet channels to inner cross-sectional area of all of the plurality of slotted outlet channels of greater than 1 to 1.

Alternatively, or additionally, in some aspects of the gas filter element, each of the plurality of inlet channels and each of the plurality of plurality of outlet channels or slotted outlet channels having a tapered inner cross-sectional area, the tapered inner cross-sectional area of each of the plurality of inlet channels decreasing from the first end to the second end: and tapered inner cross-sectional area of each of the plurality of slotted outlet channels decreasing from the second end to the first end.

In another aspect of the invention, a filter device is provided, the filter device comprising an aspect of the gas filter element mounted to a frame.

In yet another aspect of the invention, a filter array is provided, comprising at least one, preferably, two or more, aspects of the filter device arranged in a housing.

In yet another aspect of the invention, a filter system is provided, comprising two or more aspects of the filter array, arranged adjacent each other.

In another aspect, a method of filtering gas comprises passing gas through an aspect of the gas filter element, the method including passing gas into the inlet channel openings and the inlet channels and through the porous walls into the outlet channels and through the outlet channel openings. Typically, the gas passing into the inlet channels includes contaminants that are unable to pass through the porous walls such that the gas passing into the outlet channels and through the outlet channel openings has a reduced level of contaminants, providing a “cleaner” gas than the gas entering the gas filter element.

### BRIEF DESCRIPTION OF THE SEVERAL VIEWS OF THE DRAWING(S)

FIGS. 1A-1B are drawings showing the flow of gas through aspect of the gas filter element according to aspects of the invention. FIG. 1A shows a cross-sectional view through an aspect of the gas filter element, wherein dirty gas enters the open end of an inlet channel at the first end of the element, gas is cleaned as it passes through a common porous wall between the inlet channel and a slotted outlet channel, and clean gas exits the gas filter element through the open end of the slotted outlet channel at the second end of the element. FIG. 1B is an enlarged view of the dirty gas entry portion of the gas filter element shown in FIG. 1A, showing the dirty gas and clean gas flow paths, inlet channels separated from slotted outlet channels (channels illustrated here as having generally rectangularly-shaped channels) by porous walls, also showing the inlet channel having an inner cross-sectional area exceeding the inner cross-sectional area of the slotted outlet channel, wherein walls close off the slotted outlet channels at the first end of the element (walls closing off the inlet channels at the second end of the element not shown).

FIGS. 2A-2I are drawings showing a gas filter element according to an aspect of the invention. FIGS. 2A and 2B are drawings showing, respectively, isometric views of the gas filter element at the first end (dirty gas entry) and at the second end (clean gas exit).

FIGS. 2C and 2D are drawings showing, respectively, the first end (dirty gas entry) and the second end (clean gas exit) the gas filter element shown in FIGS. 2A and 2B, wherein the outlet channels are closed at the first end, and the inlet channels are closed at the second end.

FIG. 2E is a side view of the gas filter element shown in FIGS. 2A and 2B.

FIG. 2F is a drawing showing a horizontal cross-sectional view of the element along line 2F-2F of FIG. 2E, also showing 4 slotted outlet channels surrounding, and adjacent to, the 4 sides of each inlet channel, and supports at the intersection of the slotted outlet channels, in a repeating pattern. FIG. 2G is a drawing showing a vertical cross-sectional view of the element along line 2G-2G of FIG. 2E, FIG. 2H is a drawing showing an enlarged view of detail 2H (open end outlet channels) shown in FIG. 2G, and FIG. 2I is a drawing showing an enlarged view of detail 2I (closed end outlet channels) shown in FIG. 2G.

FIGS. 3A-3I are drawings showing a gas filter element according to another aspect of the invention, wherein the illustrated aspect includes tapered flow channels, each of the plurality of inlet channels and each of the plurality of plurality of slotted outlet channels having a tapered inner cross-sectional area, the tapered inner cross-sectional area of each of the plurality of inlet channels decreasing from the first end to the second end; and tapered inner cross-sectional area of each of the plurality of slotted outlet channels decreasing from the second end to the first end.

FIGS. 3A and 3B are drawings showing, respectively, isometric views of the gas filter element at the first end (dirty gas entry) and at the second end (clean gas exit). FIGS. 3C and 3D are drawings showing, respectively, the first end (dirty gas entry) and the second end (clean gas exit) the gas filter element shown in FIGS. 3A and 3B, wherein the outlet channels are closed at the first end, and the inlet channels are closed at the second end.

FIG. 3E is a side view of the gas filter element shown in FIGS. 3A and 3B. FIG. 3F is a drawing showing a horizontal cross-sectional view of the element along line 3F-3F of FIG. 3E, also showing 2 slotted outlet channels surrounding, and adjacent to, 2 opposing sides of each inlet channel, and supports at the intersection of the slotted outlet channels, in a repeating pattern. FIG. 3G is a drawing showing a vertical cross-sectional view of the element along line 3G-3G of FIG. 3E, FIG. 3H is a drawing showing an enlarged view of detail 3H (open end outlet channels) shown in FIG. 3G, and FIG. 3I is a drawing showing an enlarged view of detail 3I (closed end outlet channels) shown in FIG. 3G.

FIGS. 4A-4I are drawings showing a gas filter element according to another aspect of the invention, wherein each inlet channel surrounded by outlet channels forms an individual channel unit, each individual channel unit surrounded by a gap, such that adjacent individual channel units do not contact one another. FIGS. 4A and 4B are drawings showing, respectively, isometric views of the gas filter element at the first end (dirty gas entry) and at the second end (clean gas exit). FIGS. 4C and 4D are drawings showing, respectively, the first end (dirty gas entry) and the second end (clean gas exit) the gas filter element shown in FIGS. 4A and 4B, wherein the outlet channels are closed at the first end, and the inlet channels are closed at the second end.

FIG. 4E is a side view of the gas filter element shown in FIGS. 4A and 4B. FIG. 4F is a drawing showing a horizontal cross-sectional view of the element along line 4F-4F of FIG. 4E, also showing outlet channels surrounding, and adjacent to, inlet channels, inlet channels surrounded by outlet channels forming individual channel units in a repeating pattern, each individual channel unit surrounded by a gap, such that adjacent individual channel units do not contact one another. FIG. 4G is a drawing showing a vertical cross-sectional view of the element along line 4G-4G of FIG. 4E, FIG. 4H is a drawing showing an enlarged view of detail 4H (open end outlet channels) shown in FIG. 4G, and FIG. 4I is a drawing showing an enlarged view of detail 4I (closed end outlet channels) shown in FIG. 4G.

FIGS. 5A-5I are drawings showing a gas filter element according to yet another aspect of the invention, wherein each inlet channel surrounded by outlet channels forms an individual channel unit, each individual channel unit surrounded by a gap along a partial length from the first end to the second end, wherein adjacent individual channel units contact one another by at least one support bracket between the first end and the second end of the element.

FIGS. 5A and 5B are drawings showing, respectively, isometric views of the gas filter element at the first end (dirty gas entry) and at the second end (clean gas exit). FIGS. 5C and 5D are drawings showing, respectively, the first end (dirty gas entry) and the second end (clean gas exit) the gas filter element shown in FIGS. 5A and 5B, wherein the outlet channels are closed at the first end, and the inlet channels are closed at the second end.

FIG. 5E is a side view of the gas filter element shown in FIGS. 5A and 5B. FIG. 5F is a drawing showing a horizontal cross-sectional view of the element along line 5F-5F of FIG. 5E, through the support bracket connecting individual channel units, also showing outlet channels surrounding, and adjacent to, inlet channels, inlet channels surrounded by outlet channels forming individual channel units in a repeating pattern, wherein there are gaps along partial lengths of the first end to the second end (above and/or below the support bracket[s]).

FIG. 5G is a drawing showing a vertical cross-sectional view of the element along line 5G-5G of FIG. 5E, also showing 3 vertically arranged support brackets, FIG. 5H is a drawing showing an enlarged view of detail 5H (open end outlet channels) shown in FIG. 5G, and FIG. 51 is a drawing showing an enlarged view of detail F (closed end outlet channels) shown in FIG. 5I.

FIGS. 6A-6E are drawings showing aspects of gas filter devices comprising gas filter elements mounted to a frame, also showing an aspect of a filter array comprising a plurality of gas filter devices arranged in a housing, also showing an aspect of a gas filter system comprising an aspect of a filter array, the system including a blowback duct associated with the housing. FIG. 6A is top view of a gas filter system with the top wall of the housing removed; FIG. 6B is a view of the system shown in FIG. 6A along section 6B-6B, FIG. 6C is a view of the system shown in FIG. 6A along section 6C-6C; FIG. 6D is a view of the system shown in FIG. 6C showing an enlarged view of detail 6D; and FIG. 6E is a top view of the gas filter system shown in FIG. 6A with the top wall of the housing present.

### DETAILED DESCRIPTION OF THE INVENTION

An aspect of the invention provides a gas filter element, comprising a first end and a second end, having a plurality of inlet channels and a plurality of slotted outlet channels between the first end and the second end, wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded by 4 slotted outlet channels; each of the plurality of inlet channels and each of the plurality of plurality of slotted outlet channels having an inner cross-sectional area, each of the plurality of inlet channels having an inner cross-sectional area exceeding the inner cross-sectional area of each of the plurality of slotted outlet channels; the plurality of inlet channels and the plurality of slotted outlet channels having common porous walls.

In accordance with another aspect of the invention, a gas filter element comprises: a first end and a second end, having a plurality of inlet channels and a plurality of slotted outlet channels between the first end and the second end, wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded on 2 opposing sides by 2 slotted outlet channels; each of the plurality of inlet channels and each of the plurality of plurality of slotted outlet channels having an inner tapered cross-sectional area, the tapered inner cross-sectional area of each of the plurality of inlet channels decreasing from the first end to the second end; and the tapered inner cross-sectional area of each of the plurality of slotted outlet channels decreasing from the second end to the first end; the plurality of inlet channels and the plurality of slotted outlet channels having common porous walls.

In accordance with another aspect of the invention, a gas filter element comprises: a first end and a second end, having a plurality of inlet channels and a plurality of outlet channels between the first end and the second end, wherein, in an alternating pattern, the plurality of inlet channels each have an inlet channel opening at the first end, and are closed at the second end, and the plurality of outlet channels each have an outlet channel closed at the first end, and an opening at the second end, each outlet channel forming a gap between adjacent inlet channels, the gap extending to the second end; each of the plurality of inlet channels being surrounded by outlet channels, each inlet channel surrounded by outlet channels forming an individual channel unit, each individual channel unit surrounded by the gap extending to the second end, such that adjacent individual channel units do not contact one another; the plurality of inlet channels and the plurality of outlet channels in each individual channel unit having common porous walls.

In accordance with another aspect of the invention, a gas filter element comprises: a first end and a second end, having a plurality of inlet channels and a plurality of outlet channels between the first end and the second end, wherein, in an alternating pattern, the plurality of inlet channels each have an inlet channel opening at the first end, and are closed at the second end, and the plurality of outlet channels each have an outlet channel closed at the first end, and an opening at the second end, each outlet channel forming a gap between adjacent inlet channels along a partial length between the first end and the second end; each of the plurality of inlet channels being surrounded by outlet channels, each inlet channel surrounded by outlet channels forming an individual channel unit, each individual channel unit surrounded by the gap along the partial length between the first end and the second end, wherein adjacent individual channel units are held together by a support bracket: the plurality of inlet channels and the plurality of outlet channels in each individual channel unit having common porous walls.

In typical aspects of the gas filter element, each of the plurality of inlet channels and each of the plurality of plurality of outlet channels have an inner cross-sectional area, each of the plurality of inlet channels having an inner cross-sectional area exceeding the inner cross-sectional area of each of the plurality of outlet channels. However, in some aspects each of the plurality of inlet channels have an inner cross-sectional area equal to the inner cross-sectional area of each of the plurality of outlet channels.

In some aspects of the gas filter element, the element has a ratio of inner cross-sectional area of all of the plurality of inlet channels to inner cross-sectional area of all of the plurality of slotted outlet channels of greater than 1 to 1, e.g., 1.4 to 1; 5 to 1, 10 to 1, 14 to 1. However, in some other aspects, the element has a ratio of inner cross-sectional area of all of the plurality of inlet channels to inner cross-sectional area of all of the plurality of slotted outlet channels of 1 to 1.

Alternatively, or additionally, in some aspects of the gas filter element, each of the plurality of inlet channels and each of the plurality of plurality of slotted outlet channels having a tapered inner cross-sectional area, the tapered inner cross-sectional area of each of the plurality of inlet channels decreasing from the first end to the second end; and tapered inner cross-sectional area of each of the plurality of slotted outlet channels decreasing from the second end to the first end.

In another aspect of the invention, a filter device is provided, the filter device comprising an aspect of the gas filter element mounted to a frame.

In yet another aspect of the invention, a filter array is provided, comprising at least one, preferably, two or more, aspects of the filter device arranged in a housing.

In yet another aspect of the invention, a filter system is provided, comprising two or more aspects of the filter array, arranged adjacent each other.

In another aspect, a method of filtering gas comprises passing gas through an aspect of the gas filter element, the method including passing gas into the inlet channel openings and the inlet channels and through the porous walls into the outlet channels and through the outlet channel openings. Typically, the gas passing into the inlet channels includes contaminants that are unable to pass through the porous walls such that the gas passing into the outlet channels and through the outlet channel openings has a reduced level of contaminants, providing a “cleaner” gas than the gas entering the gas filter element.

Advantageously, since the outlet channels and slotted outlet channels are generally more narrow (e.g., smaller cross-sectional area) than the inlet channels (e.g., having a larger cross-sectional area), a higher pressure differential is provided, imparting more separation between the gas and contaminants. A desirable pressure differential can be additionally provided in those aspects having tapered channels.

If desired, aspects of the gas filter elements are suitable for cleaning by backflow, wherein gas is passed through the outlet channel openings at the second end, through the porous walls, and through the inlet channel openings at first end, wherein filter cake accumulating on the porous walls of the inlet channels can be dislodged.

For industrial applications in particular, gas filter elements have excellent mechanical strength, having been tested for over 20,000 blowback cycles and over 200,000 fatigue cycles in laboratory tests.

In some aspects, an individual channel unit can flex slightly under pressure, advantageously providing for improved cleaning during backflow by loosening some of the accumulated filter cake.

Each of the components of the invention will now be described in more detail below, wherein like components have like reference numbers.

In accordance with aspects of the gas filter according to the invention, dirty gas enters the open end of an inlet channel at the first end of the element, gas is cleaned as it passes through a common porous wall between the inlet channel and an outlet channel, and clean gas exits the gas filter element through the open end of the outlet channel at the second end of the element.

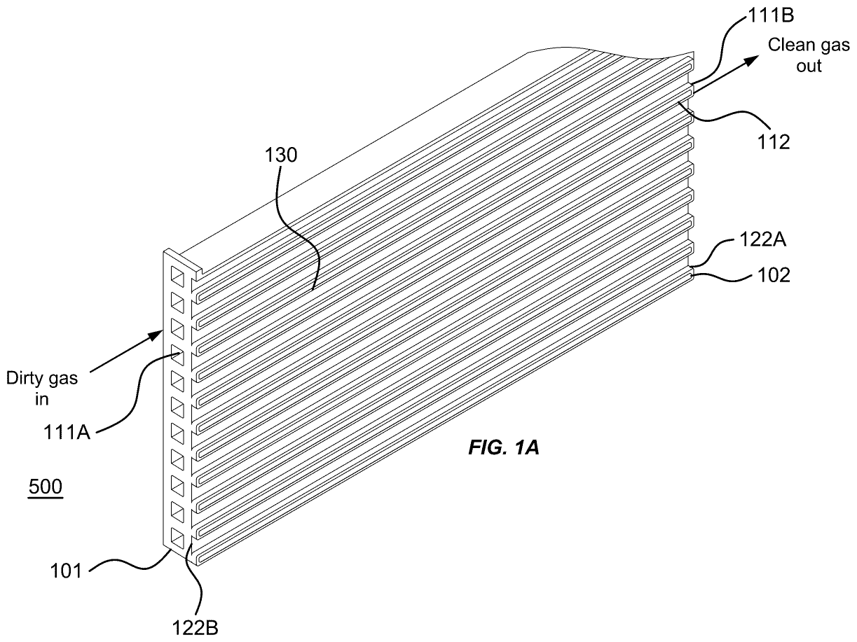

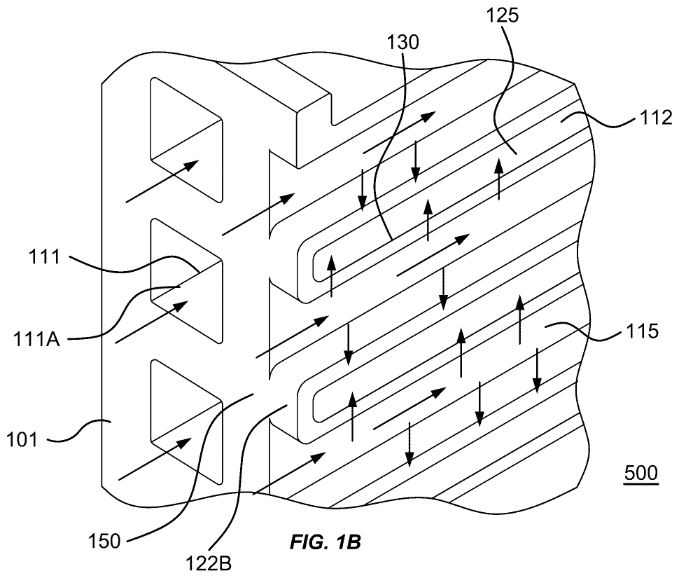

In the illustrated aspect shown in FIGS. 1A-1B, dirty gas enters the open end 111A of an inlet channel 111 at the first end 101 of the gas filter element 500, gas is cleaned as it passes through a common porous wall 130 between the inlet channel 111 and an outlet channel 112, and clean gas exits the gas filter element through the open end 122A of the outlet channel at the second end 102 of the gas filter element. In the aspect shown in FIG. 1B, each of the plurality of inlet channels and each of the plurality of plurality of slotted outlet channels having inner cross-sectional areas 115, 125, respectively.

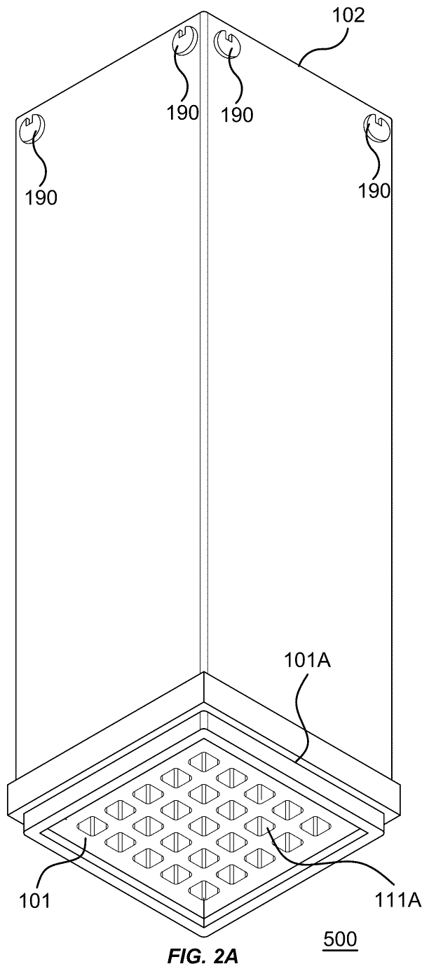

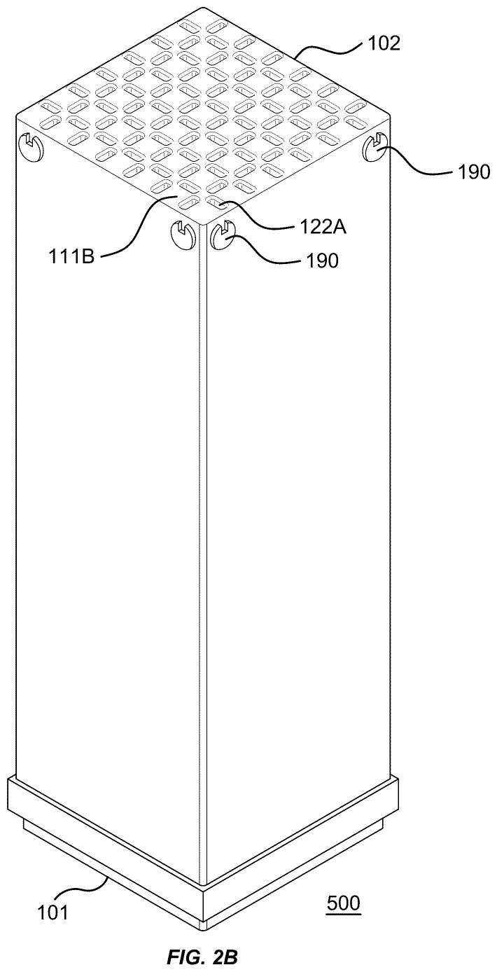

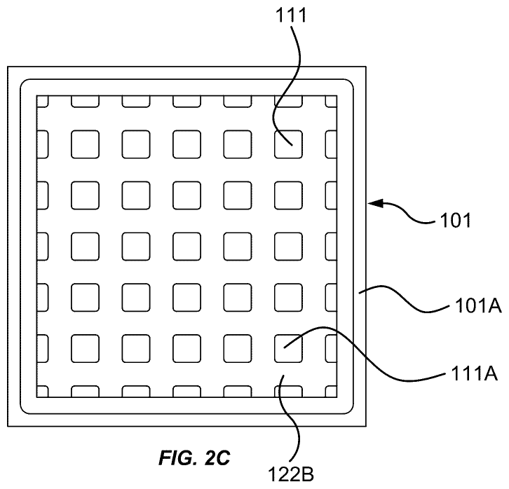

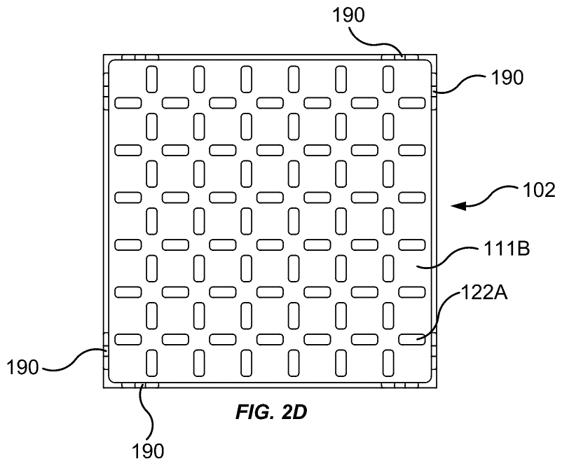

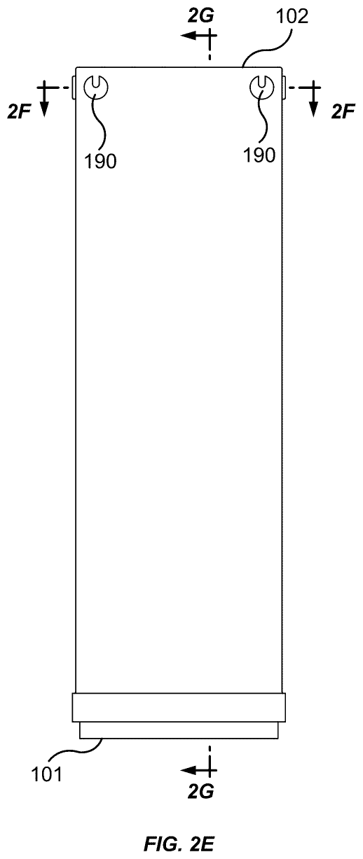

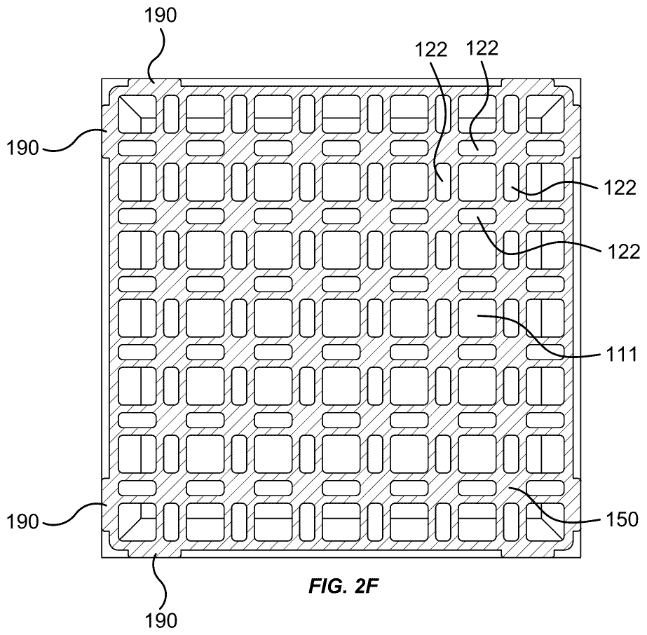

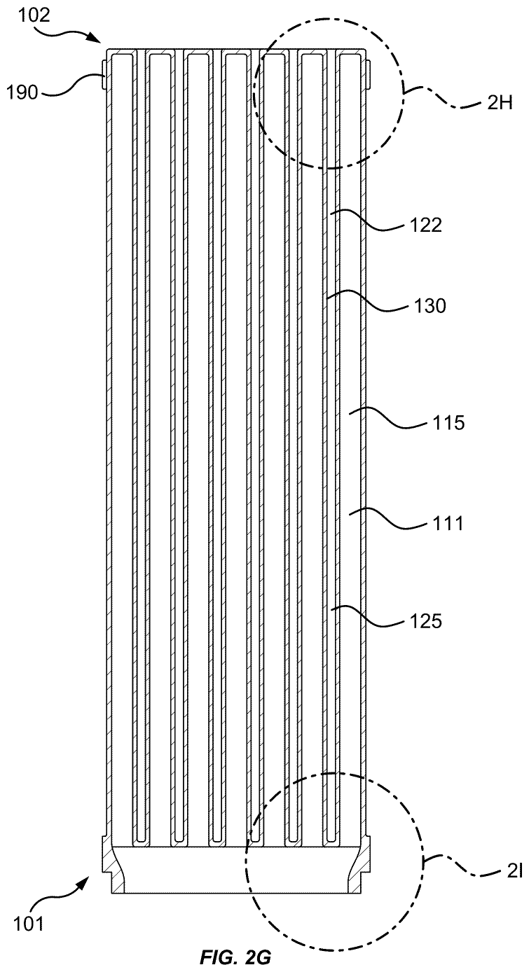

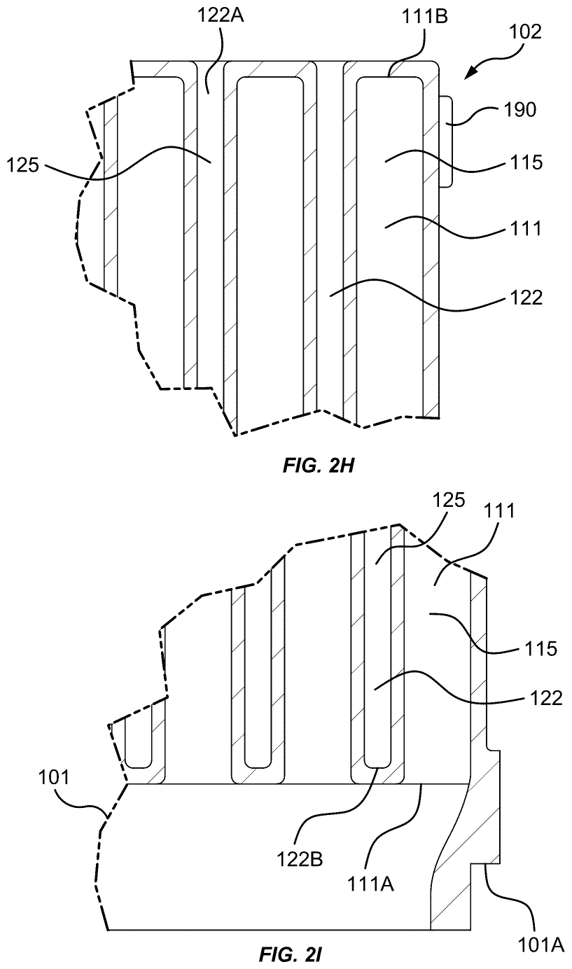

In the illustrated aspects shown in FIGS. 2A-2I, the gas filter element 500 comprises a first end 101 and a second end 102, having a plurality of inlet channels 111 and a plurality of slotted outlet channels 122 between the first end and the second end, wherein, in an alternating pattern, the plurality of inlet channels 111 each have an inlet channel opening 111A at the first end, and are closed 111B at the second end, and the plurality of slotted outlet channels 122 each have a slotted outlet channel opening 122A (illustrated as having a generally rectangularly-shaped slot opening) at the second end, and are closed 122B at the first end, each of the plurality of inlet channels being surrounded by 4 slotted outlet channels (see, for example, FIG. 2F); each of the plurality of inlet channels and each of the plurality of plurality of slotted outlet channels having an inner cross-sectional area (115, 125, respectively), each of the plurality of inlet channels having an inner cross-sectional area exceeding the inner cross-sectional area of each of the plurality of slotted outlet channels; the element having a ratio of inner cross-sectional area of all of the plurality of inlet channels to inner cross-sectional area of all of the plurality of slotted outlet channels of greater than 1; the plurality of inlet channels and the plurality of slotted outlet channels having common porous walls 130. In the aspect illustrated in, for example, FIG. 2F, a support 150 is present along the intersections of the slotted outlet channels.

In the aspect shown in, for example, FIGS. 2B-2D, both the slotted outlet channels 122 (illustrated as having generally rectangularly-shaped channels; see also, FIG. 1B) at the first end 101 and the inlet channels 111 at the second end 102 are blocked at 122B and 111B. While these blocked ends are structurally similar to, or identical in structure to, porous walls 130, due to less resistance, gas will flow through the open ends and along the inlet and outlet channels, rather than the blocked ends.

In the illustrated aspect (see, for example, FIGS. 2C and 2D), the openings 111A (inlet channel openings) at the first end 101 are all the same larger size, while the openings 122A (slotted channel openings) at the second end 102 are all the same smaller size.

In some aspects, the first end 101 includes a lip 101A, e.g., for mounting to a frame to provide a filter device.

In some aspects of any of the gas filter elements, using the gas filter element illustrated in FIG. 2A for general reference, a gas filter element can include one or more optional spacers 190 (shown as 2 spacers on each of the 4 sides of the gas filter element near second end 102).

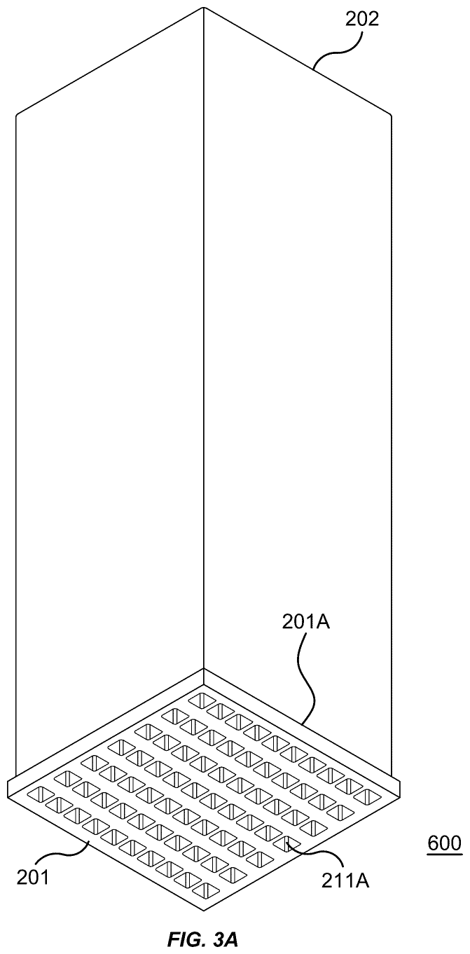

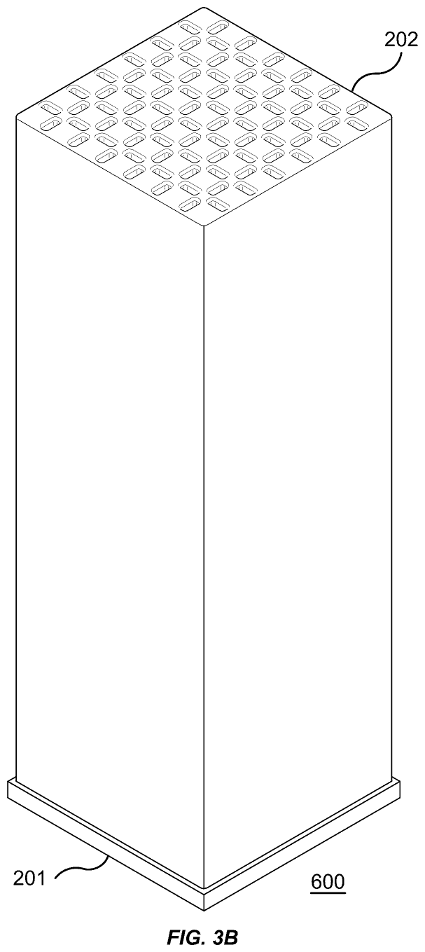

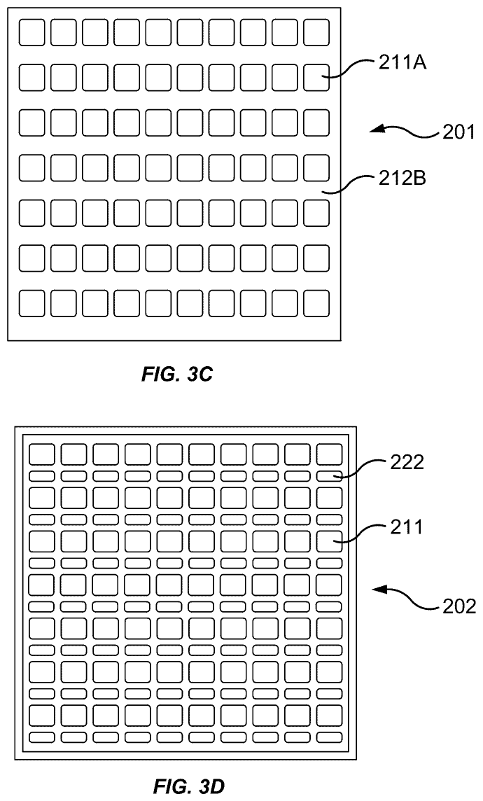

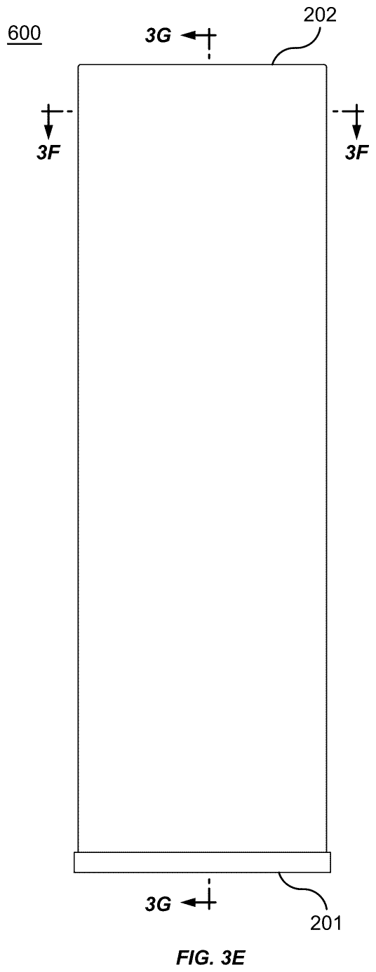

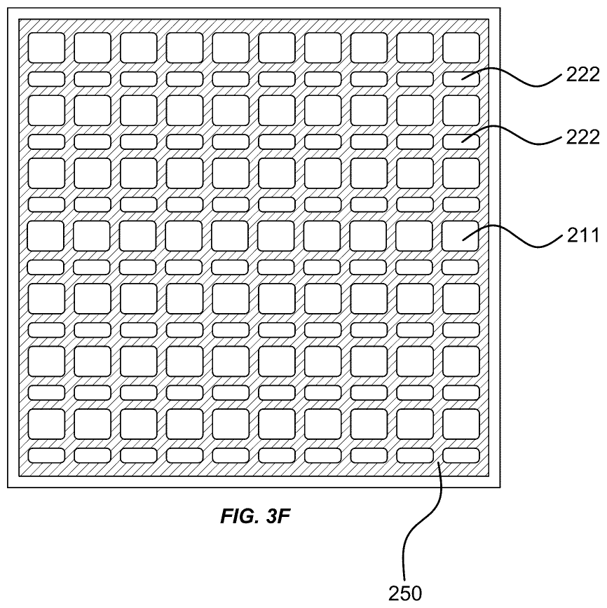

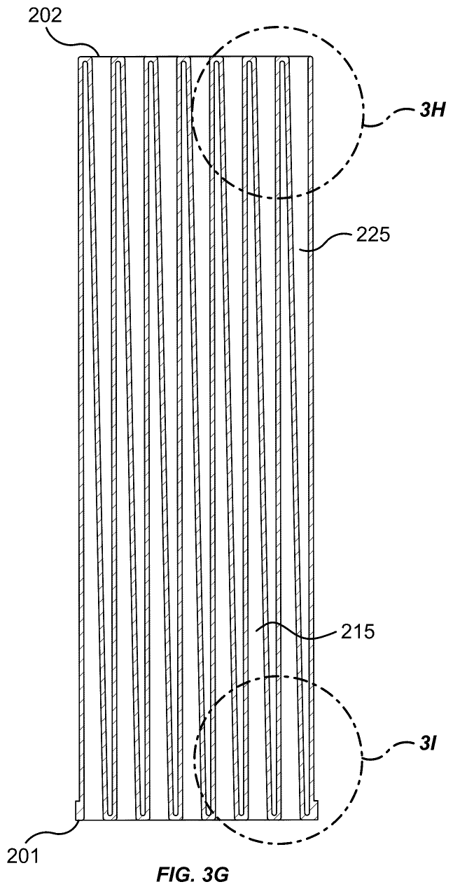

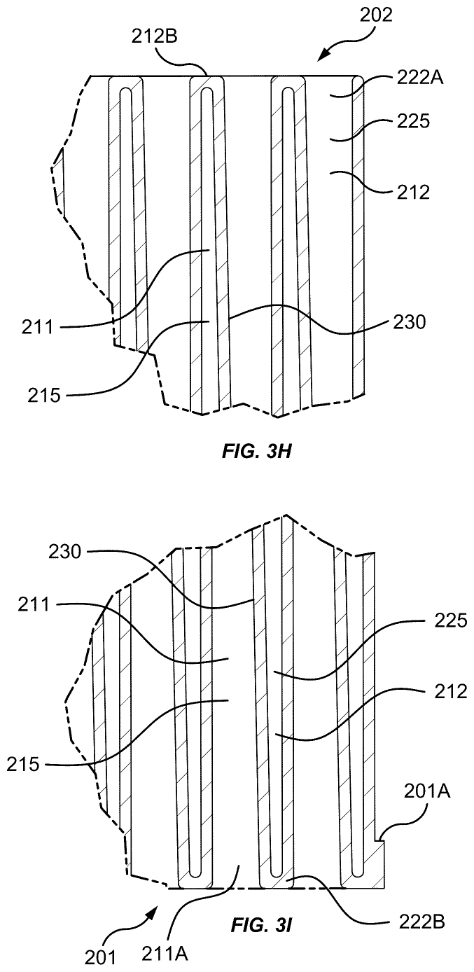

In the illustrated aspects shown in FIGS. 3A-3I, the gas filter element 600 comprises a first end 201 and a second end 202, having a plurality of inlet channels 211 and a plurality of slotted outlet channels 222 between the first end and the second end, wherein, in an alternating pattern, the plurality of tapered inlet channels 211 each have an inlet channel opening 211A at the first end, and are closed 211B at the second end, and the plurality of slotted outlet channels 222 each have a slotted outlet channel opening 222A (illustrated as having a generally rectangularly-shaped slot opening) at the second end, and are closed 222B at the first end, each of the plurality of inlet channels being surrounded on 2 opposing sides by 2 slotted outlet channels (see, for example, FIG. 3F); each of the plurality of inlet channels and each of the plurality of plurality of slotted outlet channels having a tapered inner cross-sectional area (215, 225, respectively), the tapered inner cross-sectional area of each of the plurality of inlet channels decreasing from the first end to the second end; and the tapered inner cross-sectional area of each of the plurality of slotted outlet channels decreasing from the second end to the first end: the plurality of inlet channels and the plurality of slotted outlet channels having common porous walls 230. In the aspect illustrated in, for example, FIG. 3F, a support 250 is present along the intersections of the slotted outlet channels.

In aspects of the gas filter element 600, each of the plurality of inlet channels and each of the plurality of plurality of outlet channels have an inner cross-sectional area, each of the plurality of inlet channels having an inner cross-sectional area exceeding the inner cross-sectional area of each of the plurality of outlet channels. However, in some other aspects each of the plurality of inlet channels have an inner cross-sectional area equal to the inner cross-sectional area of each of the plurality of outlet channels.

In the aspect shown in, for example, FIGS. 3B-3D, both the slotted outlet channels 222 at the first end 201 and the inlet channels 211 at the second end 202 are blocked at 222B and 211B. While these blocked ends are structurally similar to, or identical in structure to, porous walls 230, due to less resistance, gas will flow through the open ends and along the inlet and outlet channels, rather than the blocked ends.

In the illustrated aspect (see, for example, FIGS. 3C and 3D), the openings 211A (inlet channel openings) at the first end 201 are all the same larger size, while the openings 222A (slotted channel openings) at the second end 202 are all the same smaller size.

In some aspects, the first end 201 includes a lip 201A, e.g., for mounting to a frame to provide a filter device.

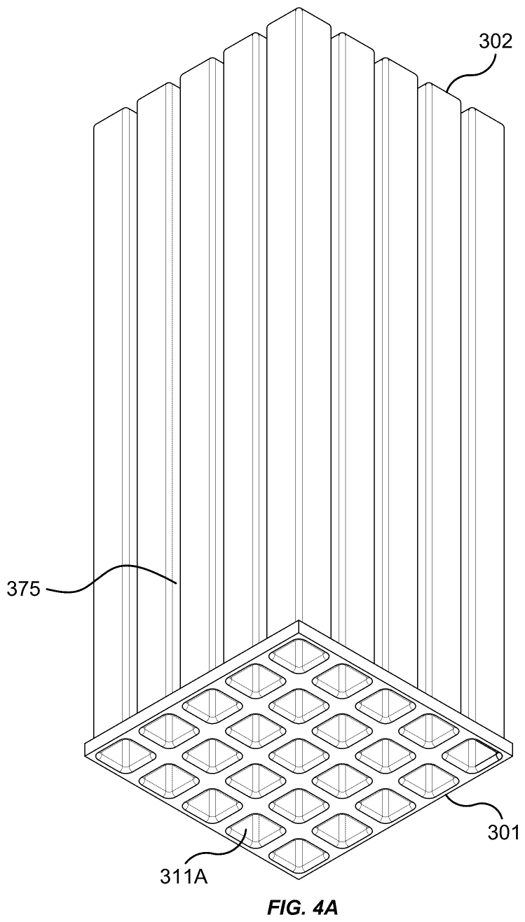

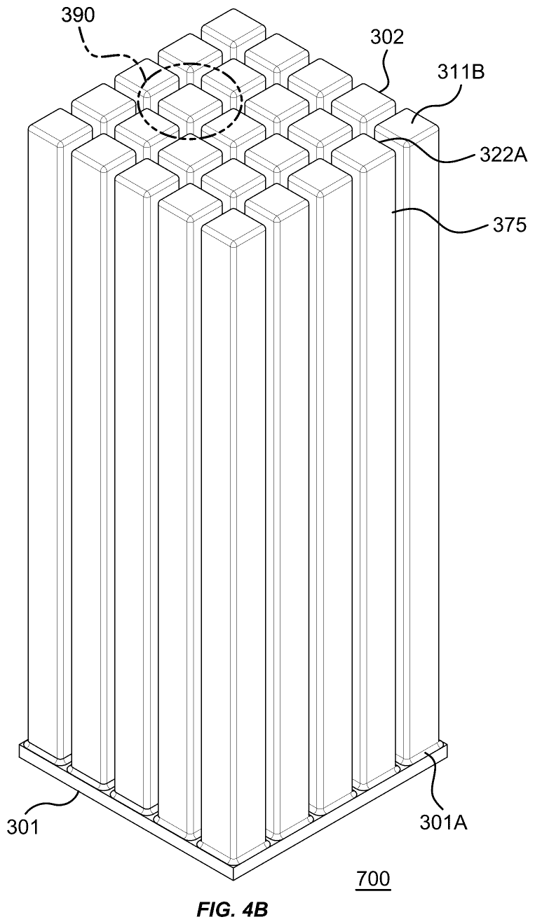

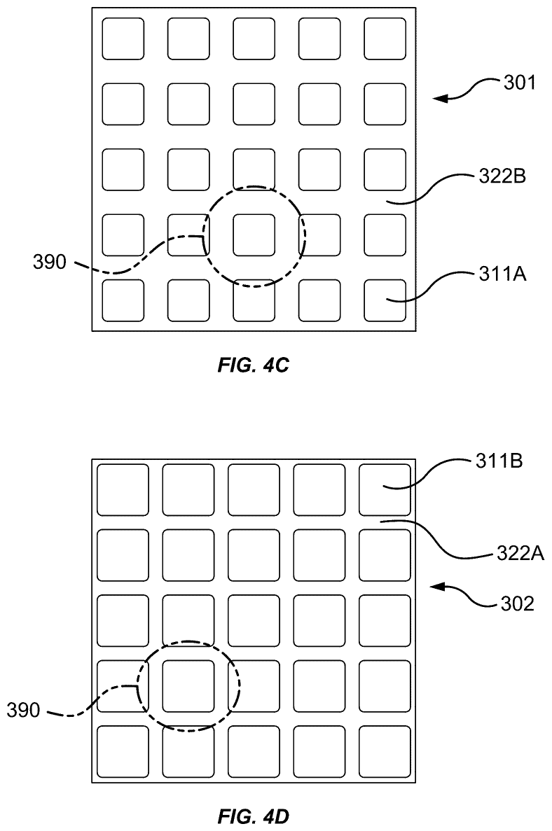

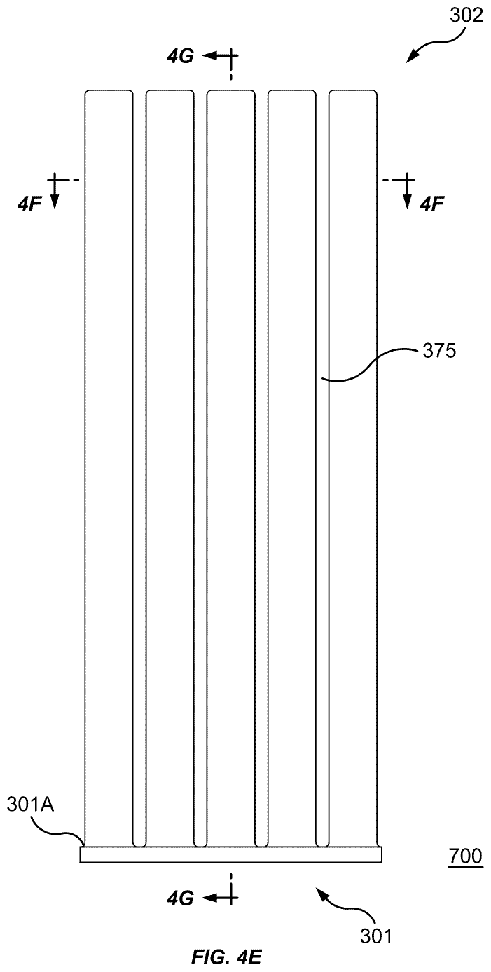

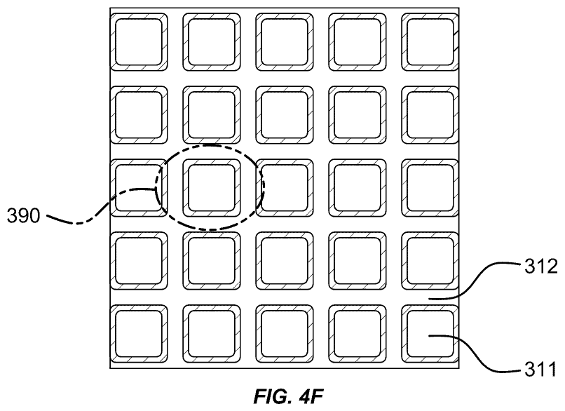

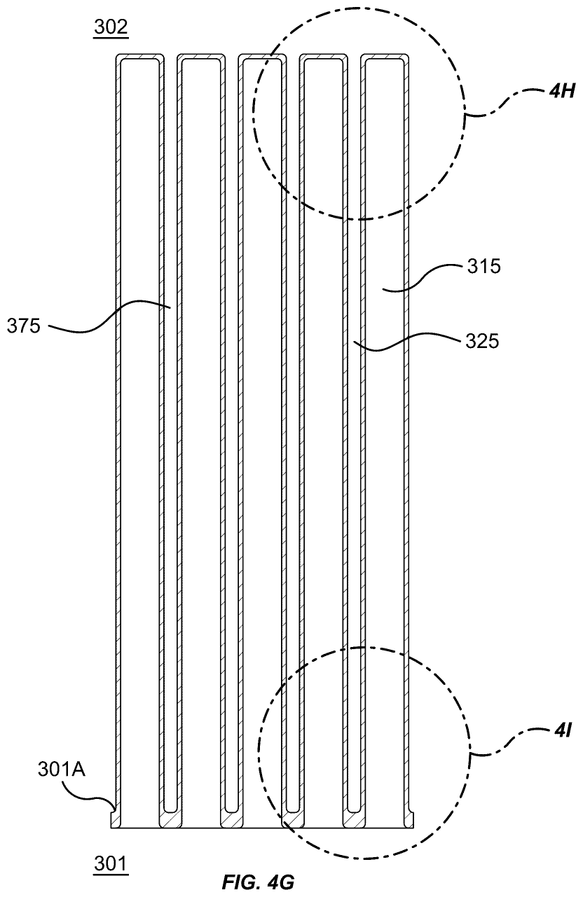

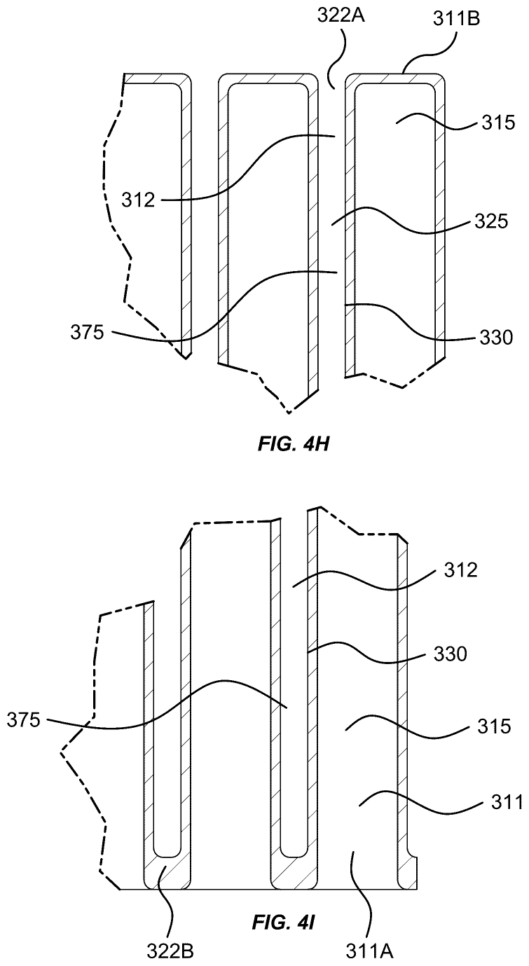

In the illustrated aspects shown in FIGS. 4A-4I, the gas filter element 700 comprises a first end 301 and a second end 302, having a plurality of inlet channels 311 and a plurality of outlet channels 322 between the first end and the second end, wherein, in an alternating pattern, the plurality of inlet channels 311 each have an inlet channel opening 311A at the first end, and are closed 311B at the 600e second end, and the plurality of outlet channels 322 each have an outlet channel opening 322A at the second end, and are closed 322B at the first end, each outlet channel 322 forming a gap 375 between adjacent inlet channels 311, the gap extending to the second end; each of the plurality of inlet channels being surrounded by outlet channels, each inlet channel surrounded by outlet channels forming an individual channel unit 390, each individual channel unit surrounded by the gap 375 extending to the second end, such that adjacent individual channel units do not contact one another; each of the plurality of inlet channels and each of the plurality of plurality of slotted outlet channels having an inner cross-sectional area (315, 325, respectively), the plurality of inlet channels and the plurality of outlet channels having common porous walls 330.

In the aspect shown in, for example, FIGS. 4B-4D, both the outlet channels 322 at the first end 301 and the inlet channels 311 at the second end 302 are blocked at 322B and 311B. While these blocked ends are structurally similar to, or identical in structure to, porous walls 330, due to less resistance, gas will flow through the open ends and along the inlet and outlet channels, rather than the blocked ends.

In some aspects, the first end 301 includes a lip 301A, e.g., for mounting to a frame to provide a filter device.

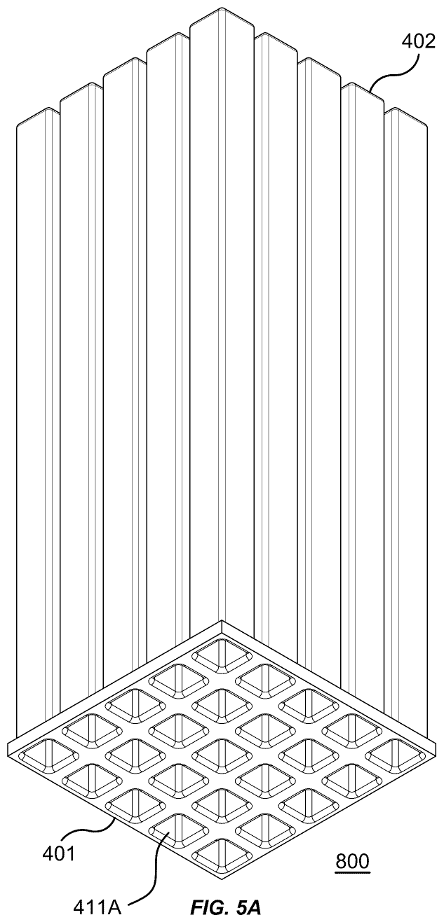

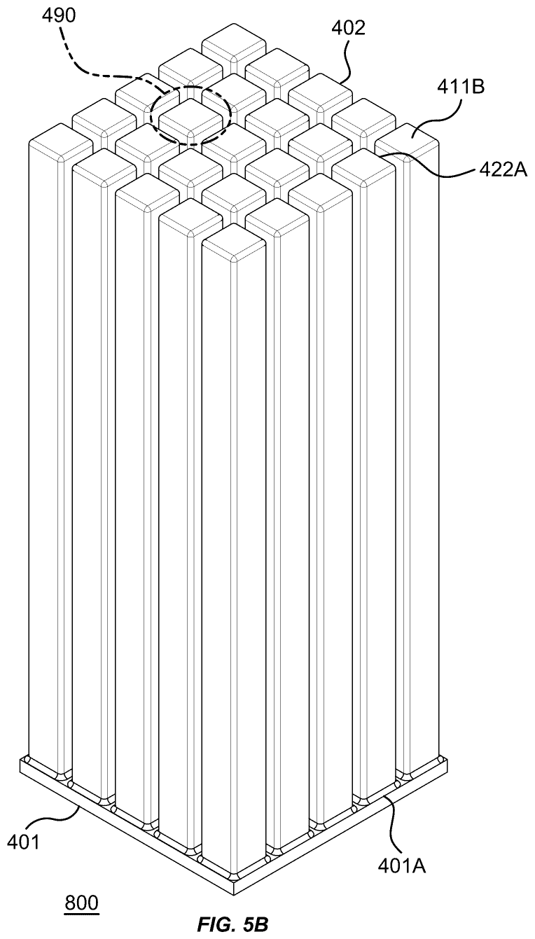

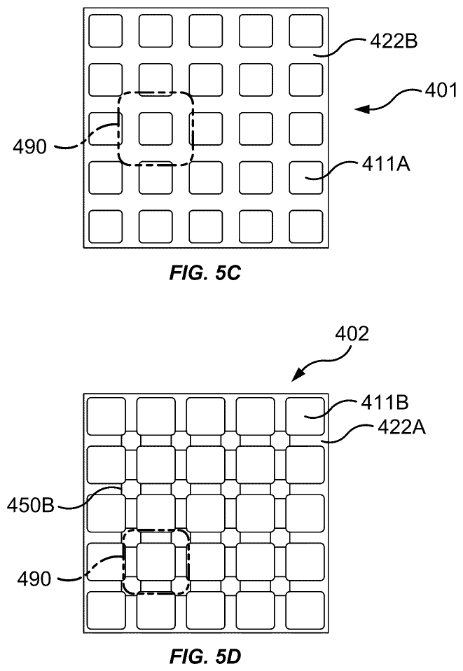

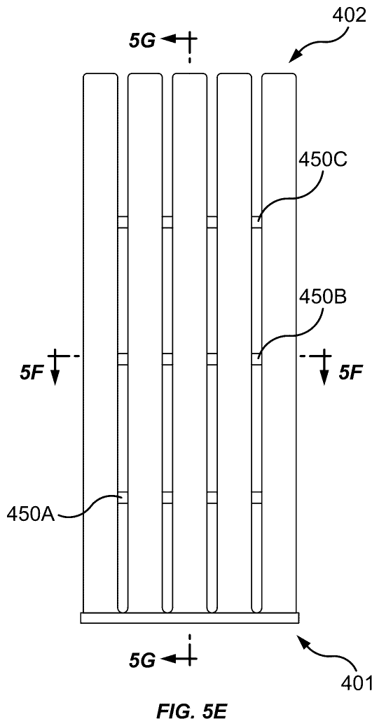

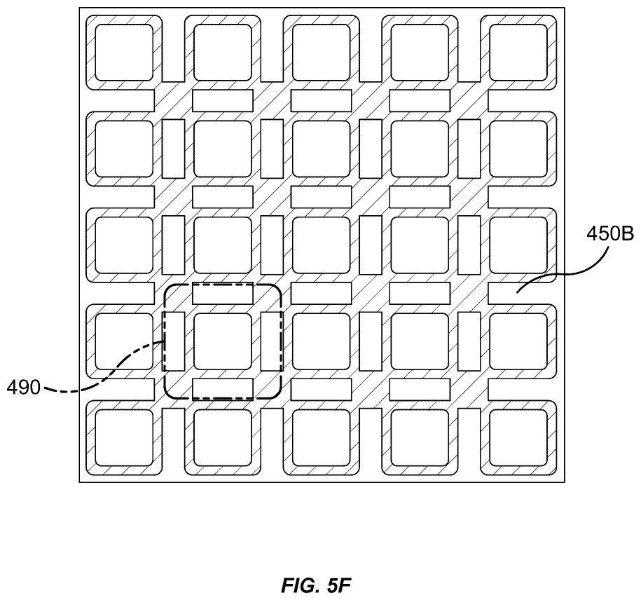

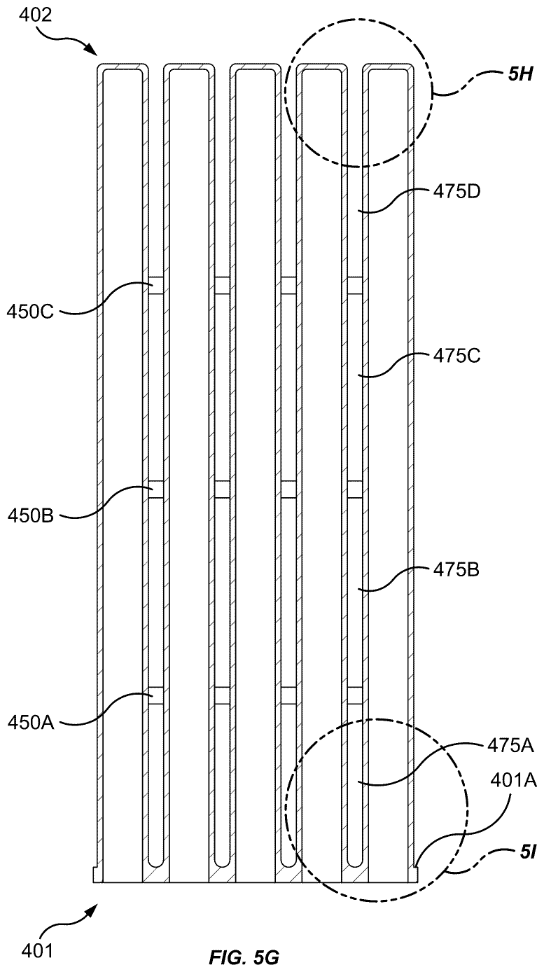

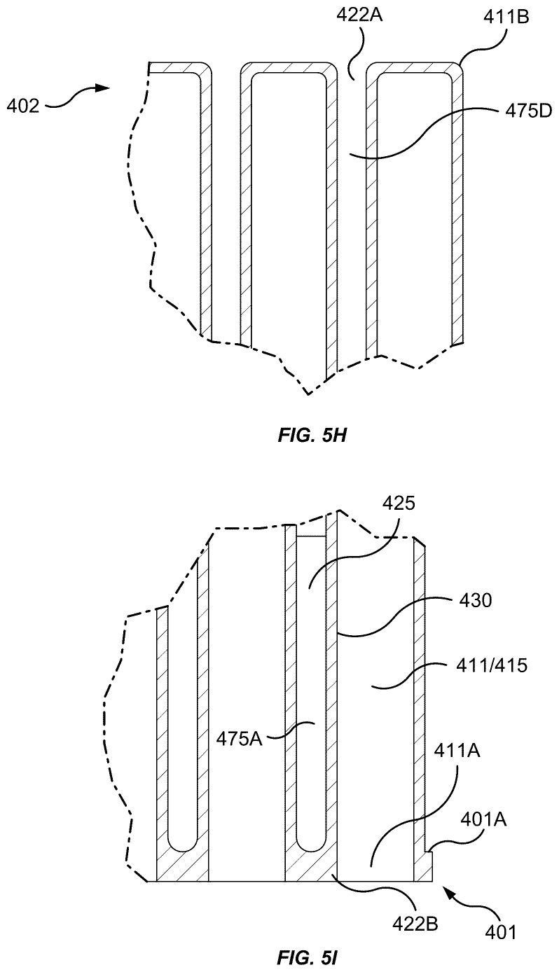

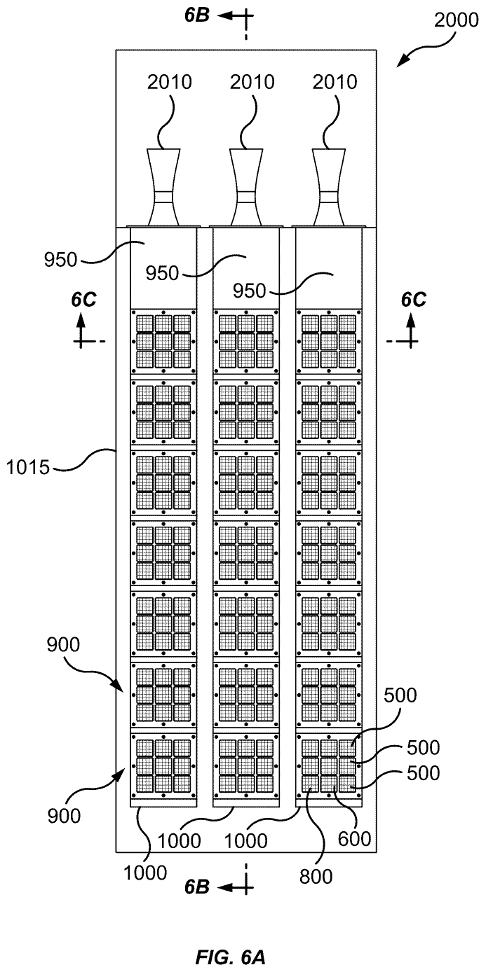

In the illustrated aspects shown in FIGS. 5A-5I, the gas filter element 800 comprises a first end 401 and a second end 402, having a plurality of inlet channels 411 and a plurality of outlet channels 422 between the first end and the second end, wherein, in an alternating pattern, the plurality of inlet channels 411 each have an inlet channel opening 411A at the first end, and are closed 411B at the second end, and the plurality of outlet channels 422 each have an outlet channel opening 422A at the second end, and are closed 422B at the first end, each outlet channel 422 forming at least one gap 475 (illustrated as gaps 475A, 475B, 475C, and 475D) between adjacent inlet channels 411 along a partial length between the second end and the second end (illustrated as separate gaps above and/or below a support bracket 450; illustrated as first support bracket 450A, second support bracket 450B, third support bracket 450C, and fourth support bracket 450D), wherein the gap is not continuous between the first and the second end; each of the plurality of inlet channels being surrounded by outlet channels, each inlet channel surrounded by outlet channels forming an individual channel unit 490, each individual channel unit surrounded by the at least one gap along the partial length between the first end and the second end, wherein adjacent individual channel units are held together by at least one support bracket; each of the plurality of inlet channels and each of the plurality of plurality of slotted outlet channels having an inner cross-sectional area (415, 425, respectively), the plurality of inlet channels and the plurality of outlet channels in each individual channel unit having common porous walls 430.

In the aspect shown in, for example, FIGS. 5B-5D, both the outlet channels 422 at the first end 401 and the inlet channels 411 at the second end 402 are blocked at 422B and 411B. While these blocked ends are structurally similar to, or identical in structure to, porous walls 430, due to less resistance, gas will flow through the open ends and along the inlet and outlet channels, rather than the blocked ends.

In some aspects, the first end 401 includes a lip 401A, e.g., for mounting to a frame to provide a filter device.

The porous walls can have any suitable pore structure, e.g., a pore size (for example, as evidenced by bubble point, or by KL as described in, for example, U.S. Pat. No. 4,340,479, or evidenced by capillary condensation flow porometry), a mean flow pore (MFP) size (e.g., when characterized using a porometer, for example, a Porvair Porometer (Porvair plc, Norfolk, UK), or a porometer available under the trademark POROLUX (Porometer.com; Belgium)), a pore rating, a pore diameter (e.g., when characterized using the modified OSU F2 test as described in, for example, U.S. Pat. No. 4,925,572), or removal rating media. In some aspects, the porous walls can have a mix of pore structures, e.g., in the range of 5 to 20 micrometers, or a pore structure of, for example, 10 micromenters.

Optionally, in some aspects, the porous walls include one or more catalysts, e.g., for nitrous oxide(s) reductions, sulfur removal and/or sulfur oxide(s) removal. Illustrative catalysts suitable for nitrous oxide(s) reduction include, for example, MnOx, Mn—TiO₂, Cu/Al₂O₃; illustrative catalysts suitable for sulfur reduction include, for example, Ca(OH)₂ and NaHCO₃, and illustrative catalysts suitable for simultaneous nitrous oxide(s) and sulfur oxide(s) reductions reduction include, for example, Fe₂O₃.

Filter elements can be, for example, formed from ceramics, e.g., silica, and from stainless steel powder, such as 316 low-carbon stainless steel and 310 stainless steel, by a process including sintering. Other suitable metal powders include, for example, alloys (e.g., HASTELLOY® X, and HAYNES® HR-160® (Haynes International); and Inconel 600), nickel, chromium, tungsten, copper, bronze, aluminum, platinum, iron, magnesium, cobalt, or a combination (including a combination of metals and metal alloys) thereof.

Filter elements according to embodiments of the invention can be monolithic, e.g., manufactured via additive manufacturing (sometimes referred to as “additive layer manufacturing” or “3D printing”). They are typically formed by repeated depositions of a metal powder bound together with an activatable binder (e.g., binder jetting, sometimes referred to as “drop on powder”), typically followed by agglomerating the powder, e.g., by sintering. If present, housing elements, extensions, and other components, can be manufactured together via additive manufacturing in a continuous operation at substantially the same time.

Any suitable additive manufacturing equipment can be used, and a variety of production 3D printers are suitable and commercially available.

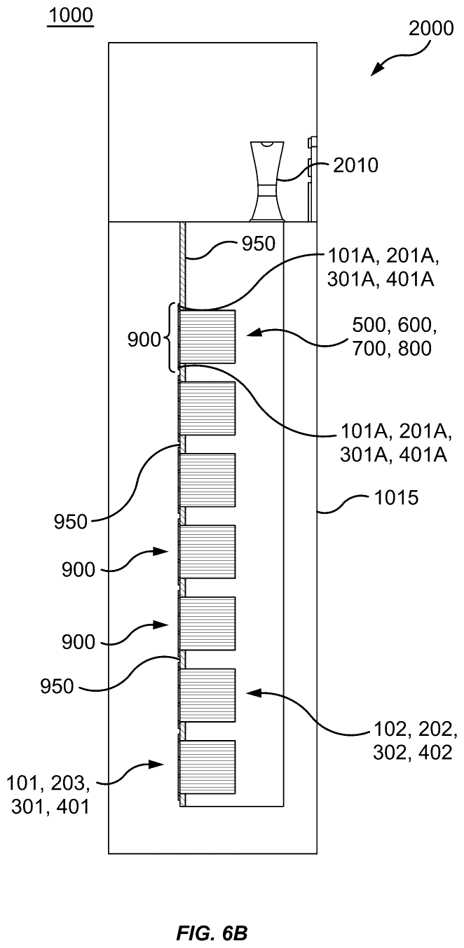

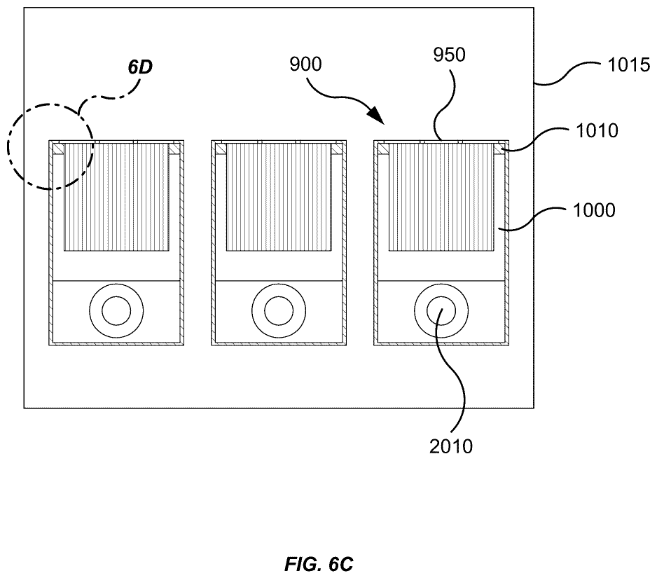

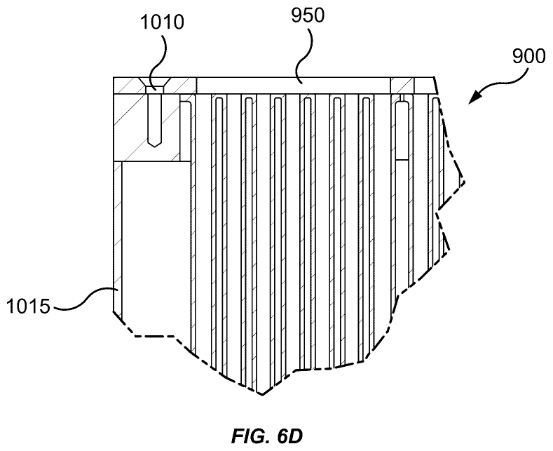

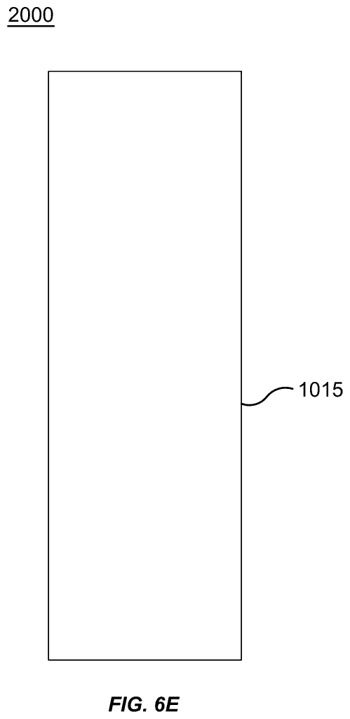

In another aspect of the invention, a gas filter device is provided, the filter device comprising an aspect of the gas filter element mounted to a frame. For example, FIGS. 6A-6D show a plurality of gas filter devices 900, each gas filter device comprising two or more aspects of a gas filter element (illustrated as gas filter element 500, 600, 700, 800, each illustrated gas filter device including 9 gas filter elements; see, FIG. 6A) mounted to a frame 950, wherein the frame includes an opening for receiving the gas filter element, for example, wherein the first end of the gas filter element (the first end can comprise a plate) includes a lip (illustrated as 101A, 201A, 301A, 401A) extending outwardly preventing the first end from passing through the opening in the frame. The lip can be placed in direct contact with the edge of the opening and, if desired, adhered thereto, or, for example, a gasket can be placed between the lip and the edge of the opening.

In yet another aspect of the invention, a gas filter array is provided, comprising at least one, preferably, two or more, aspects of the filter device arranged in a housing. For example, using FIGS. 6A-6D for reference, the illustrated gas filter array 1000 comprises two or more gas filter devices mounted to a frame 950, arranged in a housing 1015. In the aspect of the gas filter array shown in FIG. 6B, each of the 3 gas filter arrays 1000 includes 7 gas filter devices 900, each gas filter device including 9 gas filter elements.

In yet another aspect of the invention, using FIGS. 6A-6D for reference, a gas filter system 2000 is provided (FIG. 6E showing an external view of the system 2000; since the rear of the system is typically open, a rear view would be similar to that shown in FIG. 6C), comprising at least one gas filter array 1000 comprising two or more aspects of the gas filter device 900, wherein the filter devices are arranged consecutively adjacent each other; preferably, wherein the filter system further comprises a blowback duct 2015.

Using the aspect shown in FIG. 6B for reference, the illustrated aspect of the gas filter system 2000 comprises a filter array 1000 comprising two or more aspects of the filter devices 900 arranged linearly in the housing 1015, and a blowback duct 2015 arranged at one end of the housing, the blowback duct arranged to operate at the second ends 102, 202, 302, 402 of the gas filter elements. Thus, gas passed through the blowback duct passes through the outlet channel openings at the second end of each of the gas filter devices in the gas filter array, through the porous walls, and through the inlet channel openings at the first ends 101, 201, 301, 401, dislodging filter cake accumulated on the porous walls in the inlet channels.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred aspects of this invention are described herein, including the best mode known to the inventors for carrying out the invention. Variations of those preferred aspects may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gas filter element comprising:
a first end and a second end, having a plurality of inlet channels and a plurality of slotted outlet channels between the first end and the second end,
wherein, in an alternating pattern, the plurality of inlet channels each have an inlet channel opening at the first end, and are closed at the second end, and the plurality of slotted outlet channels each have a slotted outlet channel opening at the second end, and are closed at the first end, each of the plurality of inlet channels being surrounded by 4 slotted outlet channels;
each of the plurality of inlet channels and each of the plurality of plurality of slotted outlet channels having an inner cross sectional area, each of the plurality of inlet channels having an inner cross sectional area exceeding the inner cross sectional area of each of the plurality of slotted outlet channels;
the plurality of inlet channels and the plurality of slotted outlet channels having common porous walls.

2. The gas filter element of claim 1, having a ratio of inner cross sectional area of all of the plurality of inlet channels to inner cross sectional area of all of the plurality of outlet channels of greater than 1 to 1.

3. A method of filtering gas, the method comprising passing gas through the gas filter element of claim 1, the method including passing gas into the inlet channel openings and the inlet channels and through the porous walls into the outlet channels and through the outlet channel openings.

4. A gas filter device comprising the gas filter element of claim 1, mounted to a frame.

5. A gas filter array, comprising at least one gas filter device according to claim 4 arranged in a housing.

6. A gas filter system comprising two or more gas filter arrays according to claim 5, arranged adjacent each other.

7. A method of filtering gas, the method comprising passing gas through the gas filter element of claim 2, the method including passing gas into the inlet channel openings and the inlet channels and through the porous walls into the outlet channels and through the outlet channel openings.

8. A gas filter device comprising the gas filter element of claim 2, mounted to a frame.

9. A gas filter array, comprising at least one gas filter device according to claim 8 arranged in a housing.

10. A gas filter system comprising two or more gas filter arrays according to claim 9, arranged adjacent each other.
